(19) United States
(12) Patent Application Publication
(10) Pub. No.: US 2016/0341879 A1
(43) Pub. Date: Nov. 24, 2016

(54) BACKLIGHT MODULE STRUCTURES

(71) Applicant: SHENZHEN CHINA STAR OPTOELECTRONICS TECHNOLOGY CO., LTD., Shenzhen, Guangdong (CN)

(72) Inventor: Yanxue ZHANG, Shenzhen, Guangdong (CN)

(73) Assignee: Shenzhen China Star Optoelectronics Technology Co., Ltd., Shenzhen, Guangdong (CN)

(21) Appl. No.: 14/422,356

(22) PCT Filed: Jan. 13, 2015
(86) PCT No.: PCT/CN2015/070639

§ 371 Date: Feb. 19, 2015

(30) Foreign Application Priority Data
Dec. 26, 2014 (CN) 201410837533.5

(51) Int. Cl. F21V 8/00

(52) U.S. Cl. CPC G02B 6/0045; G02B 6/0055; G02B 6/005; G02B 6/0088; G02B 6/0065

(57) ABSTRACT

A backlight module structure is disclosed. The backlight module structure includes: a display panel, a plurality of optical films, a light guiding plate, and a reflective sheet stacked in sequence, and masking glue arranged in a lateral side of the bottom of the display panel. A lateral portion of the light guiding plate extends along sidewalls of the optical films upward and connecting to the display panel via the masking glue. A groove is arranged in a bottom of the light guiding plate to receive the reflective sheet. A metal frame includes a first end and a second end, and the first end connects to the display panel via the masking glue and the second end sticks into the light guiding plate. In this way, the plastic frame arranged in a middle-lateral portion and the metal frame in the bottom of the backlight module are omitted.

### BACKGROUND OF THE INVENTION

1. Field of the Invention

The present disclosure relates to liquid crystal display technology, and more particularly to a backlight module.

2. Discussion of the Related Art

Currently, borders of backlight modules have been designed to be more narrow and thinner. However, it is difficult to guarantee the structure of the backlight module with such design. The components may be loosened or damaged, and thus the quality of the products are unpredictable.

### SUMMARY

In one aspect, a backlight module structure includes: a display panel, a plurality of optical films, a light guiding plate, and a reflective sheet stacked in sequence, and masking glue arranged in a lateral side of the bottom of the display panel; a lateral portion of the light guiding plate extending along sidewalls of the optical films upward and connecting to the display panel via the masking glue; a groove being arranged in a bottom of the light guiding plate to receive the reflective sheet; and a metal frame having a first end and a second end, the first end connects to the display panel via the masking glue, and the second end sticks into the light guiding plate.

Wherein a bending portion is provided between the first end and the second end such that a cross section of the metal frame is L-shaped or hook-shaped.

Wherein the light guiding plate is made by PMMA.

Wherein the reflective sheet is adhered or clasped within the groove.

In view of the above, the metal frame and the light guiding plate are integrated, wherein the plastic frame arranged in a middle-lateral portion and the metal frame in the bottom of the backlight module are omitted. In addition, at least one groove is arranged in the bottom of the light guiding plate for installing a reflective film so as to make the backlight module more narrow and thinner. At the same time, the structure of the metal frame is improved to obtain a stronger structure. In this way, the quality of the product is ensured.

### BRIEF DESCRIPTION OF THE DRAWINGS

FIG. 1 is a schematic view of the backlight module in accordance with one embodiment.

### DETAILED DESCRIPTION OF THE EMBODIMENTS

Embodiments of the invention will now be described more fully hereinafter with reference to the accompanying drawings, in which embodiments of the invention are shown.

According to the present disclosure, the structure of the backlight module is improved. In addition, not only narrow border and thinner design may be realized, but also the structure of the product may be guaranteed.

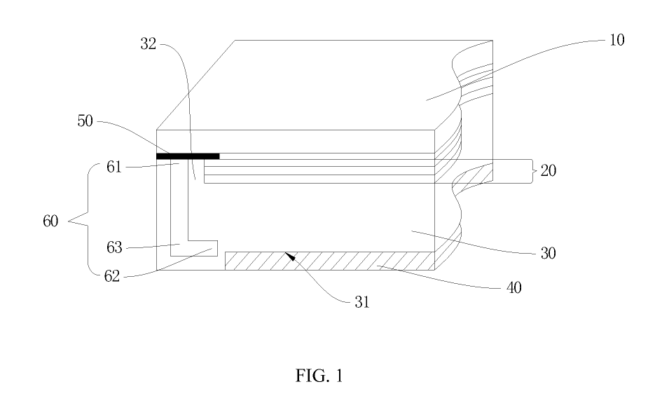

As shown in FIG. 1, the backlight module includes a display panel 10, a plurality of optical films 20, a light guiding plate 30, and a reflective sheet 40 stacked in sequence. In addition, the backlight module also includes masking glue 50 and a metal frame 60 arranged in a lateral side of the bottom of the display panel.

A lateral portion 32 of the light guiding plate 30 extend along sidewalls of the optical films 20 upward and then connects to the display panel 10 via the masking glue 50. A groove 31 is arranged in the bottom of the light guiding plate 30 to receive the reflective sheet 40. In the embodiment, the reflective sheet 40 is adhered within the groove 31 via adhesive. In other embodiments, the groove may be configured to be engage with the reflective sheet such that the reflective sheet is clasped within the groove.

The metal frame 60 includes a first end 61 and a second end 62. The first end 61 connects to the display panel 10 via the masking glue 50. The second end 62 sticks into the light guiding plate 30 such that the metal frame 60 and the light guiding plate 30 are integrated.

Preferably, in order to stably connect the metal frame and the light guiding plate, a bending portion 63 is provided between the first end 61 and the second end 62 such that the cross section of the metal frame 60 is L-shaped or hook-shaped. During the manufacturing process, the light guiding plate may be made by PMMA, which is one kind of optical acrylic material. The structure of the metal frame 60 is made, and then the masking glue 50 is inserted into the PMMA material. The PMMA material and the metal frame are then integrated by processes such as injection molding or casting.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. backlight module structure, comprising:
a display panel, a plurality of optical films, a light guiding plate, and a reflective sheet stacked in sequence, and masking glue arranged in a lateral side of the bottom of the display panel;
a lateral portion of the light guiding plate extending along sidewalls of the optical films upward and connecting to the display panel via the masking glue;
a groove being arranged in a bottom of the light guiding plate to receive the reflective sheet; and
a metal frame having a first end and a second end, the first end connects to the display panel via the masking glue, and the second end sticks into the light guiding plate.

2. The backlight module structure as claimed in claim 1, wherein a bending portion is provided between the first end and the second end such that a cross section of the metal frame is L-shaped or hook-shaped.

3. The backlight module structure as claimed in claim 1, wherein the light guiding plate is made by PMMA.

4. The backlight module structure as claimed in claim 1, wherein the reflective sheet is adhered or clasped within the groove.
